(19) United States
(12) Patent Application Publication
(10) Pub. No.: US 2009/0240628 A1
(43) Pub. Date: Sep. 24, 2009

(54) Method and System for Facilitating a Negotiation

(75) Inventors: William R. Blair, Gibsonia, PA (US); Richard P. Berlin, Cranberry Twp., PA (US); Venkata Paparao Gummadapu, Wexford, PA (US)

Correspondence Address: THE WEBB LAW FIRM, P.C., 700 KOPPERS BUILDING, 436 SEVENTH AVENUE, PITTSBURGH, PA, 15219, US

(73) Assignee: CO-EXPRISE, INC., Wexford, PA (US)

(21) Appl. No.: 12/052,263

(22) Filed: Mar. 20, 2008

(51) Int. Cl. G06Q 30/00

(52) U.S. Cl. 705/80

(57) ABSTRACT

A computer-implemented method for facilitating a negotiation for at least one item or service for at least one user. The method includes dynamically adjusting the duration of at least one phase of the negotiation and/or the offer price of the item or service based at least in part upon data that is existing or obtained during the at least one phase of the negotiation. A negotiation system and negotiation control interfaces are also disclosed.

### BACKGROUND OF THE INVENTION

1. Field of the Invention

The present invention is directed to negotiation events, such as online negotiations, online auctions, reverse auctions, traditional auctions and the like and, in particular, to a method and system for facilitating a negotiation event and a computer-implemented method and system for conducting a negotiation event, preferably in a networked environment between a plurality of users.

2. Description of the Related Art

Auctions have been provided for many years, and the primary goal of the auction process is to negotiate some item or service between a buyer and seller for the fairest or optimal “market price.” Accordingly, and as is well-known in the art, the auction process includes an auctioneer (who controls and manages the auction process) and multiple participants (who submit or indicate bids for the item or service that is being offered). Initially, the auctioneer will set an adjustable offer price (in a physical auction), set a fixed bid ceiling (in an online environment) and open the auction, and the participants will begin indicating their bids (e.g., visually and/or verbally in a physical auction or submitting their bids electronically in an online environment). The auctioneer facilitates the process and, depending upon a variety of factors, ensures that the market value of the item or service is achieved. Finally, the auction is closed, and the item or service awarded to the winning bidder or participant.

As is known in the art, an auctioneer runs and manages a traditional manual auction. As each item or lot of items is presented for bid, the auctioneer makes decisions in controlling and managing the particular item or service to be auctioned, as well as the entire auction event. Accordingly, the auctioneer is constantly making decisions that are vital to both the entire event and the particular item up for bid. These decisions are based upon various inputs that he or she is receiving throughout the event. In this manner, the entire auction process has achieved its primary goal. However, while this process is effective in a physical environment, many drawbacks and deficiencies are evident when attempting to institute this auction process in an online environment, where, in many cases, the auction participants are remotely located.

When engaging in a sourcing process, the goal of any company is to obtain the market price for a given good or service, while minimizing the cost to obtain this market price. In the case of selling a particular good or service, market price is the highest price a bidder is willing to pay. In the case of buying a particular good or service, market price is the lowest price the bidder is willing to provide for the good or service, assuming all the goods or services have comparable quality. One element of cost is the amount of time it takes to effectively identify qualified suppliers and buyers and arrive at the market price.

To address the issue of global participation, the online or electronic auction process was established. The first iterations of electronic auctions permitted global bidding by many remotely located participants based upon a given “closing” time of the auction. The best bid at closing time was supposed to represent the true “market price.” In reality, bidders were able to “game” the system by waiting until the last few seconds to try to be the last bid submitted. There was still plenty of price compression (in the case of a reverse auction) or price increase (in the case of a forward auction) in the current bid price to achieve the true market price, however, the “clock” would prevent any future bidding. The “game” was to submit the last bid before the countdown reached “00:00.”

The next generation of electronic auctions attempted to address the issue of such “gaming” of the system by extending the closing time into overtimes. According to the prior art, the time duration to bid on an item or service is set in advance of opening an auction or bid lot for that item or service without the ability to dynamically adjust such time duration after the auction or bid lot opens based upon data that is existing prior to the opening of the auction/bid lot or upon data that is obtained during the auction or bid lot. As a result, the closing of each auction or bid lot is based on a prescheduled closing time. According to the prior art, overtimes are based on this prescheduled closing time such that if a bid is received within X time of the prescheduled closing time, an extension period (i.e., overtime) is initiated. According to the prior art, the time duration of one or more overtimes is also predetermined such that the time available to bid on an item or service is set in advance of the opening of such overtime or the opening of the auction or bid lot itself. Likewise, if a bid is received within X time of the prescheduled closing time of an overtime period, one or more additional overtimes are initiated. The concept was to allow bidding to continue until all bids were placed. Overtimes helped in achieving an appropriate market price, however, because the auction had fixed, predefined bid time durations, bid lots and their corresponding overtimes extended the amount of time it took to bid on particular good or services. For example, overtimes could extend the time to bid on an item or service from 5-10 minutes to 25-90 minutes. The amount of time to run a standard auction with 10-20 unique items (or lots) could take a complete business day. The excessive amount of time it takes to auction each item results in a lack of participation from potential bidders. In addition, the time-related inefficiencies of these prior art systems often resulted in bidder fatigue and additional “gaming” scenarios based on close of overtime instead of closing times, which often prevented the auctions from determining best price. Market price can only truly be obtained if all potential bidders participate in the auction process. In addition, adding extra time to a negotiation adds to the costs of all parties involved in the auction by keeping those parties from doing other activities required by their companies.

Similar to fixing and predetermining the time duration of an auction and corresponding overtimes, the prior art also predetermined a fixed bid ceiling (or floor) without the ability to dynamically adjust the bid ceiling (or floor) higher or lower after the auction or bid lot opens based upon data that is existing prior to the opening of the auction/bid lot or upon data that is obtained during the auction/bid lot. According to the prior art, the offer price in an electronic auction is only permitted to move in one direction (upward in a forward auction or downward in a reverse auction) based on bids submitted by bid participants during the auction, however, the adjusting of such offer price is limited to the fixed bid ceiling (or floor) and/or limited by the amount of submitted bids. As a result, many online auctions result in little to no bidder activity due to the inability to adjust the offer price only based on submitted bids or due to setting a fixed bid ceiling (or floor) that does not incite bidders to participate.

### SUMMARY OF THE INVENTION

It is, therefore, an object of the present invention to provide a method and system for facilitating a negotiation that overcomes the drawbacks and deficiencies of the prior art. It is another object of the present invention to provide a method and system for facilitating a negotiation that allows for the management and control of the negotiation process. It is a further object of the present invention to provide a method and system for facilitating a negotiation that is configured for online or electronic negotiations of all types, including without limitation online upward auctions, reverse auctions, multiple-round sealed bids, multiple-round quotations, etc. and methods including, but not limited to, indexed negotiations, multi-offering negotiations, multi-variant negotiations and combinatorial negotiations. It is yet another object of the present invention to provide a method and system for facilitating a negotiation that allows for the efficient arrival at the market price for the item or service. It is a still further object of the present invention to provide a method and system for facilitating a negotiation that provides a user interface for use in engaging in the negotiation process. It is another object of the present invention to provide a method and system for facilitating a negotiation that provides a control interface that assesses bidder intent, much like a human auctioneer in the context of a manual gavel auction, for use in managing an online auction process. It is a still further object of the present invention to provide a method and system for facilitating a negotiation that allows for the dynamic adjustment of a phase of the negotiation and/or offer price of an item or service during the negotiation.

According to one embodiment, provided is a computer-implemented method of facilitating a negotiation for at least one item or service. The method includes: entering at least one phase of the negotiation for the at least one item or service; and dynamically adjusting the duration of the at least one phase of the negotiation based at least in part upon data that is existing or obtained during the at least one phase of the negotiation.

According to a further embodiment, provided is a computer-implemented method of facilitating a negotiation for at least one item or service, wherein the method includes: setting an offer price for the at least one item or service; and dynamically adjusting the offer price for the at least one item or service based at least in part upon data that is existing or obtained during the at least one phase of the negotiation.

In a still further embodiment, provided is a computer-implemented method of facilitating a negotiation for at least one item or service. In this embodiment, the method includes: entering at least one phase of the negotiation for the at least one item or service; and setting an offer price for the at least one item or service. The method further includes dynamically adjusting at least one of (i) the duration of the at least one phase and (ii) the offer price for the at least one item or service, based at least in part upon data that is existing or obtained during at least one phase of the negotiation.

In another embodiment, provided is a negotiation system for facilitating a negotiation for at least one item or service. The system includes a central negotiation system configured or adapted to: (i) enter at least one phase of the negotiation for the at least one item or service; (ii) set an offer price for the at least one item or service; and (iii) dynamically adjust at least one of (i) the duration of the at least one phase and (ii) the offer price for the at least one item or service, based at least in part upon data that is existing or obtained during at least one phase of the negotiation. A communication system facilitates data communication between a plurality of users.

In yet another embodiment, provided is a negotiation control interface for use in connection with a negotiation system for facilitating a negotiation for at least one item or service. The negotiation control interface includes at least one area for presenting bidder intent data to a control user. The bidder intent data is received, stored, processed or transmitted from the central negotiation system.

In a still further embodiment, provided is a negotiation control interface for use in connection with a negotiation system for facilitating a negotiation for at least one item or service. The negotiation control interface includes at least one area accessible by a user to configure at least one rule that defines at least one parameter of the negotiation. Based upon data existing or obtained during the negotiation and the at least one rule, the system is configured to dynamically adjust at least one of the following: the duration of at least one phase of the negotiation, the offer price for the at least one item or service.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents (and vice versa) unless the context clearly dictates otherwise.

### BRIEF DESCRIPTION OF THE DRAWINGS

FIG. 1 is a schematic view of a physical auction process according to the prior art;

FIG. 2 is a schematic view of one embodiment of a computer-implemented method and system for facilitating a negotiation according to the principles of the present invention;

FIG. 3 is a schematic view of a data architecture in one embodiment of a computer-implemented method for facilitating an auction;

FIG. 4 is a flow diagram of another embodiment of a computer-implemented method for facilitating a negotiation according to the principles of the present invention;

FIG. 5 is a flow diagram of a further embodiment of a computer-implemented method for facilitating a negotiation according to the principles of the present invention;

FIG. 6 is multiple, variant views of example display indications of various embodiments of a computer-implemented method and system for facilitating a negotiation according to the principles of the present invention;

FIGS. 7(a)-(c) are exemplary screenshots of an event graph as provided by further embodiments of a computer-implemented method and system for facilitating a negotiation according to the principles of the present invention;

FIG. 8 is an example negotiation control interface for use in a computer-implemented method and system for facilitating a negotiation according to the principles of the present invention; and

FIG. 9 is an example automated negotiation control interface for use in a computer-implemented method and system for facilitating a negotiation according to the principles of the present invention.

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

According to known physical auction processes and techniques, and as illustrated schematically in FIG. 1, traditional live auctions are controlled and managed by an auctioneer A. In particular, such an auctioneer A ensures appropriate flow and other management characteristics of a traditional manual auction. As each item is presented for a bid, the auctioneer A makes appropriate decisions that manage both that particular item, as well as the entire auction event. For example, the auctioneer A sets the offer price (Box E), and controls the timing of how long an item is able to be bid upon by calling out “going once”, “going twice” and, finally, “gone” (Box F). In addition, the auctioneer A manages the audience or bidders through any unforeseen or unplanned circumstances, e.g., a bidder having emergency medical issues or power going out in a building. In this case, the auctioneer A may pause or hold the bidding process (Box G), or ensure that an item is re-opened for bid (Box H).

In order to make these critical decisions, the auctioneer A is provided with various inputs, whether visual, oral, sensory, etc. that he or she is receiving while managing the event. One of the most important inputs is the last or lead bid, which also may include a “no bid” scenario (Box I). From this last bid, the auctioneer A knows how to adjust the existing offer price and set a new offer price. However, this is not the only input and data an auctioneer A receives during the event. For example, the auctioneer A senses, understands and manages the bidding dynamics (Box J), which represents the pace of bidding from the previous bids. In addition, the auctioneer A is able to look into the audience to see the overall group acceptance and bidders' intent (Box K). For example, the auctioneer A can sense or read the audience and figure out when a bidder is ready to or contemplating placing a bid. In this case, the auctioneer A will slow down or encourage the bidder to make a decision. Still further, the auctioneer A must ensure that the overall event schedule (Box L) is managed and kept as best possible, and in order to accomplish this, the auctioneer A will increase or slow down the pace of the auction based upon the time scheduled for each item. For example, the pace of the auction may be adjusted by increasing or decreasing the bid decrement or increment (Box N). The auctioneer A also gathers information regarding any uncontrolled events (Box M) that would cause him or her to pause or hold the bidding process.

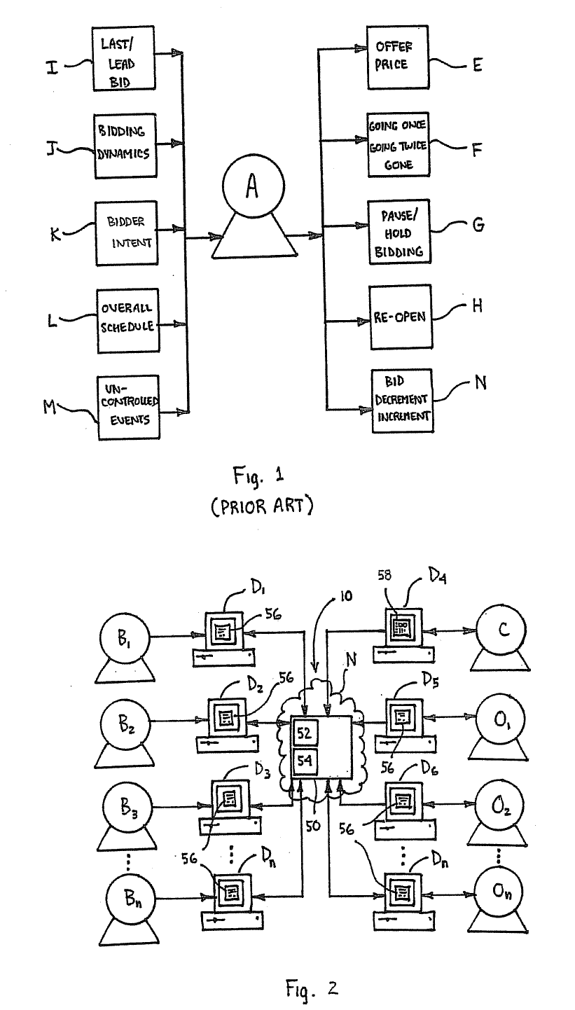

As illustrated in FIG. 2, the presently-invented method and system 10 of facilitating a negotiation may be used in connection with a variety of negotiation types, e.g., an online negotiation, an electronic negotiation, an auction, an online auction, an electronic auction, an online upward auction, a reverse auction, a multiple-round sealed bid, a multiple-round quotation, an indexed negotiation, a multi-offering negotiation, a multi-variant negotiation, a combinatorial negotiation or any combination thereof. For example, the various automated bidding processes, e.g., multi-variant bidding, and the data management capabilities associated therewith may be integrated with the present invention. Accordingly, incorporated by reference herein are the following pending patent applications: application Ser. No. 11/208,693 (entitled “File Translation Methods, Systems and Apparatuses for Extended Commerce”); application Ser. No. 11/208,694 (entitled “Cost Management File Translation Methods, Systems, and Apparatuses for Extended Commerce”); application Ser. No. 11/209,090 (entitled “Collaborative Negotiation Methods, Systems, and Apparatuses for Extended Commerce”); application Ser. No. 11/209,091 (entitled “Supplier Capability Methods, Systems, and Apparatuses for Extended Commerce”). Further, and in the context of the present invention, the phrase “offer price” is used to indicate one or more of the following: (1) invitation to deal; (2) asking price; (3) binding or non-binding offer or counteroffer with respect to either a buyer or a seller.

Taking a live auction and the dynamics associated therewith and moving it to an online or network environment N requires many different considerations. Therefore, as discussed in detail hereinafter, and as illustrated schematically in FIG. 2, provided is a method and system 10 for facilitating a negotiation, such as an online negotiation or online auction. The method is a computer-implemented method that allows for the effective management and control of a negotiation in the network environment N between remote bidders B_{1 . . . n} and an auction coordinator C. Therefore, the method and system 10 are implemented or capable of implementation on a variety of networked and/or communicating computers D_{1 . . . n}, as is well known in the art. It is envisioned that one or more additional persons associated with any one of the remote bidders B_{1 . . . n}, the auction coordinator C, and/or the entity conducting the negotiation may have access to the system 10, even though they are not directly involved in the negotiation process (between the bidders B_{1 . . . n} and the auction coordinator C (or system 10)). In particular, the present method and system 10 may permit observers O_{1 . . . n} to view the negotiation (or event) as it is taking place, and these observers O_{1 . . . n} may also be remotely connected to the system 10 via a respective communicating computer D.

The computer-implemented method may be in the form of a software program or application accessible by the bidders B, observers O, as well as the coordinator C. Therefore, the various steps in the method (as discussed hereinafter) may be remotely implemented and executed using any suitable software or computer code or instructions to facilitate the negotiation in the online or network environment N. The presently-invented method 100 and system 10 are not limited to any specific language, model, instructions, code, platform or architecture, and may be suitably implemented in a variety of forms and environments. For example, the method and system 10 may be executed or activated on the bidder's B computer D, the observer's O computer D and/or the coordinator's C computer D through a downloadable program, an executable program, in an application service provider model, a scripted program, a remotely accessible program, etc. In one preferred embodiment, the method and system 10 is implemented on a website or at a specific location on the Internet, which is accessible by the bidders B, observers O and the coordinator C. In addition, the bidders B, observers O and the coordinator C may have different access levels at the online location, or alternatively, may have different access program instructions for execution locally on the bidder's B, observer's O and coordinator's C computer D.

The method and system 10 of the present invention may be operated, implemented or utilized by a variety of users. In addition, the negotiation process may only include a single supplier and a single buyer, which may be likened to a traditional negotiation between parties. In the context of an auction, the bidder B would not be aware that they were the only bidder B in the process. However, the method and system 10 is equally useful with multiple bidders B, which normally assists in obtaining the true market value of the item or service.

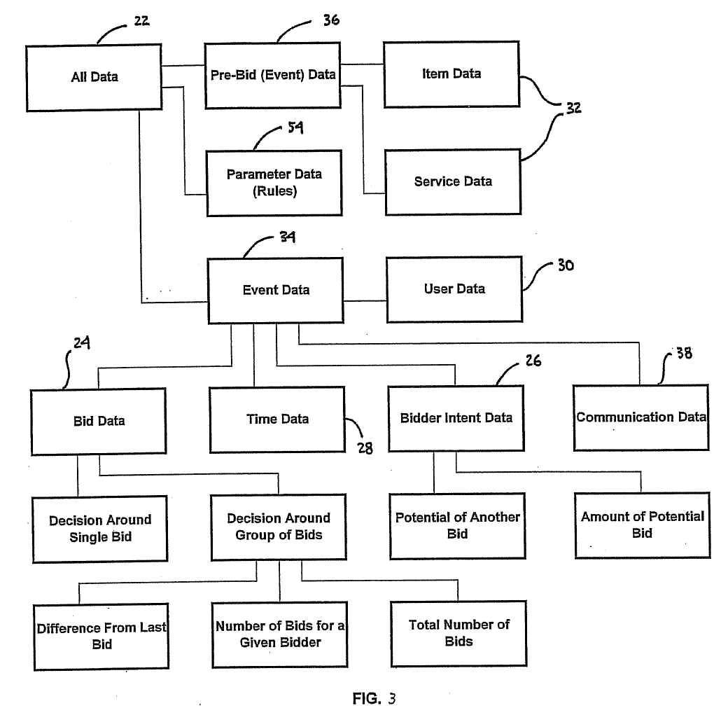

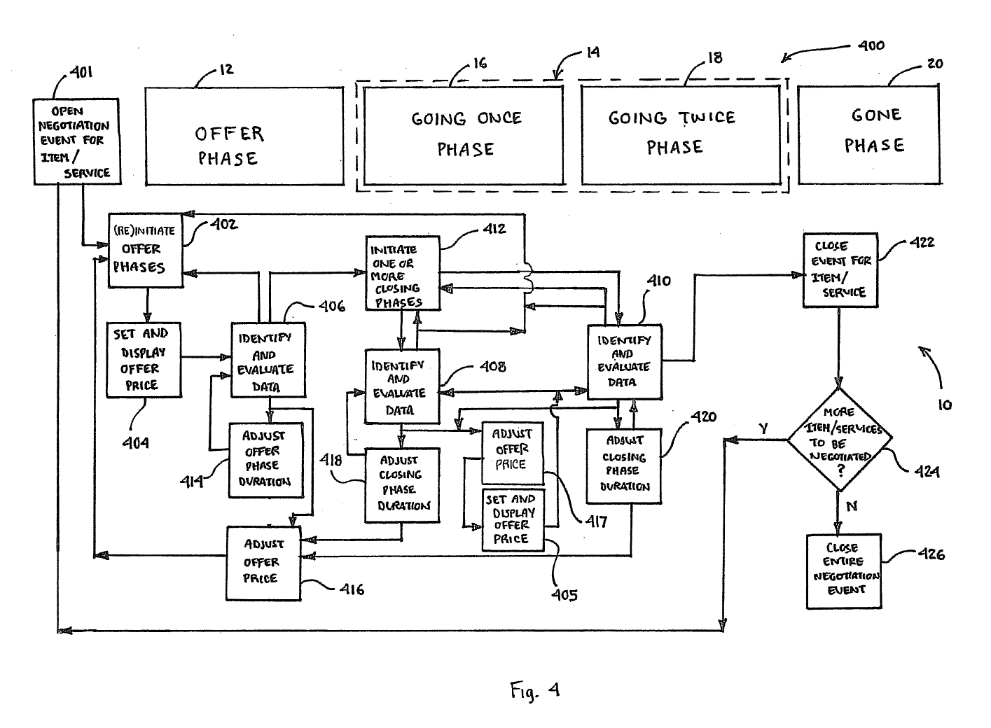

As discussed, live, physical auctions are successful because the human auctioneer A can make certain determinations and institute specified actions E-H and N based upon a variety of dynamic data inputs I-M. As illustrated in FIGS. 3 and 4, the presently-invented method and system 10 is unique in that it moves this dynamic process to an online environment, whether in an automatic, semi-automatic or human-controlled, interface-driven environment. Accordingly, in one preferred and non-limiting embodiment, the method of facilitating a negotiation for at least one item or service includes entering at least one phase of the negotiation for the at least one item or service. This phase may be an offer phase 12, a closing phase 14 (e.g., a “going once” phase 16, a “going twice” phase 18, etc.) and a “gone” phase 20.

In such a network environment N, and as opposed to having set parameters and rules, e.g., when to enter overtime and how long an overtime period is, the presently-invented method and system 10 is capable of dynamically adjusting various parameters during any particular phase of the negotiation. For example, in one embodiment, the duration of a phase 12, 14, 20 is dynamically adjusted based upon data 22 (see FIG. 3), which data 22 is existing or obtained during the phase of the negotiation. Accordingly, the method and system 10 may adjust the duration of the various phases in the same manner a human auctioneer A would during the negotiation, as opposed to, in one example the prior art, always entering a predetermined overtime period based upon a predetermined trigger and for a predetermined duration.

This data 22 that exists or is obtained during the phase of a negotiation may, in one preferred and non-limiting embodiment, be broken down into certain categories, including: bid data 24, bidder intent data 26, time data 28, user data 30, item or service data 32, event data 34, pre-event data 36 and communication data 38. In addition, and as discussed hereinafter, in certain embodiments of the present invention, parameter data or “rules” are also used in making automated or semi-automated decisions during the negotiation. Broadly considered, the event data 34 includes and/or overlaps with the bid data 24, time data 28, bidder intent data 26, communication data 38 and user data 30.

As discussed above in connection with one embodiment of the present invention, adjusting the duration of the phase is based upon various fields or data points within the described data sets. For example, the bid data 24 may include data surrounding or decisions directed to a single bid, or alternatively, a group of bids. When making decisions directed to a group of bids, various data points may be considered, such as the difference of the current bid from the last bid, the number of bids for a given bidder B, the total number of bids B, etc.

Any number of data points and fields that are existing or obtained during the phase can be used to adjust the duration of the phase, whether the offer phase 12 and/or closing phase 14. For example, the bid data 24 may include the rate of bids received, the value of the bids received, the quantity (or number) of bids received (if any), the identification of who submitted the bid, the qualification of the bid, acceptance of the bid, the position or rank of the bid in relation to other submitted bids, the time of bid submission, variance data, e.g., bid value decrement/increment, bid value in relation to other bid value, bid time submitted in relation to other bid time submitted, bid value in relation to offer price, ceiling price, floor price, reserve price, etc.

Another important category of data is the bidder intent data 26. As discussed in connection with the human auctioneer A, this auctioneer A is capable of “reading” the audience and bidders B to see whether they are close to making a bid, hesitant, likely to adjust their bid, etc. The presently-invented method and system 10 is capable of obtaining this bidder intent data 26 through communication with the bidder's B computer D. Accordingly, the system 10 may collect bidder intent data 26 indicating that the bidder B is a “potential” bidder B or about to bid, and even the amount of the bid as entered in at the bidder's B computer D. Still further, the bidder intent data 26 may include: (1) a bid that is “keyed” in at the bidder's B computer D, but not submitted; (2) adjusted “keyed” in bid up or down, but not submitted; (3) duration of time passed before, during or after bid is “keyed” in, but prior to submission; (4) number of adjustments to “keyed” in bid prior to submission; and/or (5) how a bidder B, prior to submission, adjusts and/or enters “keyed” in bid in relation to market dynamics, e.g., number of submitted bids, amount of bids, etc.

Time data 28 may include the time remaining in a phase, time remaining in a lot, time remaining in an event, phase duration, cumulative time elapsed in one or more of the phases, lots or events, schedule information, the timing sequence of the phases, items, lots and/or events, etc. The user data 30 may include the identification of the user (e.g., bidder B, buyer, supplier, observer O, administrator, coordinator C, etc.), online status of the user, user name, contact information, company information, etc. The item or service data 32 may include data describing an item (e.g., a two-dimensional drawing, a three-dimensional model, etc.) and data describing a service (e.g., service level criteria, service description, etc.).

Event data 34, as discussed, may include one or more of the data points or fields set forth above. Further, event data 34 may include lot data (e.g., phase data or identification, item or service data 32, bid data 24, result data including rank, award and rejection notification, offer price data, ceiling price data, floor price data, reserve price data, etc.) and time data 28. Pre-event data 36 may include qualification data, bidder qualification data (e.g., financial, contract terms, conditions, capabilities, licenses, etc.), pre-event quoting and/or bid submission, indicative pricing information, item or service data 32, etc. In addition, communication data 38 may include message data and would provide a feature for live chatting with presence before, during or after a negotiation. For example, this communication data 38 may include information relating to collaboration between a bidder B and the coordinator C regarding an item, service, bid, lot, phase, event, negotiation, etc. In this manner, and as can be seen, based upon one or more of these data points or existing conditions, the duration of any phase 12, 14, 20 can be dynamically adjusted during such phase based upon data 22 that exists prior to or is obtained during such phase 12, 14, 20.

In another aspect of the present invention, the method includes entering an initial offer phase 12 for the at least one item or service. Next, an offer price is set and displayed for this item or service. After moving through the dynamically-adjustable initial offer phase 12, at least one dynamically-adjustable closing phase 14 may be entered, and while in this closing phase 14, and based upon the above-discussed data points, a subsequent offer phase 12 can be entered, wherein the subsequent offer phase 12 is also dynamically adjustable as described above. For example, if the negotiation is in the “going once” phase 16, it is envisioned that various data points that are existing or obtained during this “going once” phase 16 would lead the system 10 to either adjust the duration of the “going once” phase 16 and/or adjust the offer price and enter a subsequent offer phase 12. Thereafter, and while in this subsequent offer phase 12, a subsequent closing phase 14 would be entered, again based upon the appropriate data points and dynamic information received by the system 10.

As discussed above, the negotiation may be facilitated between a number of parties and users, including bidders B, one or more coordinators C, a participating bidder B, an observer O affiliated with the participating bidder B or the bid coordinator C, etc. As discussed hereinafter, the users, whether bidder B, coordinator C, observer O, etc., will have access to an appropriate interface for interacting, whether directly or indirectly, with the system 10. After moving through the negotiation process of the present invention, and using the above-discussed data points to adjust the duration of the phase and/or the offer price, an appropriate market value for the item or service is reached. Specifically, since the method and system 10 of the present invention provide for the dynamic adjustment of the phase duration and/or offer price, bidders B are not capable of “gaming” the system or otherwise extending the negotiation to a lengthy process. Once moving through the offer phase(s) 12 and appropriate closing phases 14, the “gone” phase 20 is reached, where a bidder B is determined to be the “winner.” The system 10 would then notify the bidder B of the winning bid based upon the bidder's B bid submitted during negotiation.

In another embodiment, the method of the present invention includes setting an offer price for the item or service. In this aspect of the present invention, and regardless of whether the phase duration is dynamically adjusted or not, the offer price for the item or service is dynamically adjusted based upon the above-discussed data points. Accordingly, the offer price is not set and then simply determined by the bidder's B submitted bids. Instead, a number of factors including data 22 as described above, can be used in connection with adjusting the offer price, such as the bidder intent data 26, bid data 24, variance information and data, etc. It should also be recognized that this dynamic adjustment is bi-directional, i.e., the offer price may be adjusted up or down according to the existing or obtained data 22.

For example, the offer price may be adjusted in order to slow down or speed up the negotiation process, or otherwise provoke bidders B to bid more or less, or more or less often, all in order to arrive at a more appropriate and/or optimal market price for the item or service. Therefore, as with dynamically adjusting the duration of the phase, dynamically adjusting the offer price during the negotiation process leads to a more effective negotiation event. Accordingly, the presently-invented method and system 10 can dynamically adjust phase duration and/or offer price in order to mimic the actions and interactions of a human auctioneer A, but in a network environment N with remote users/bidders B. It should also be recognized that the dynamic adjustment of the phase duration and/or offer price is bi-directional, e.g., the phase duration and/or offer price may be increased or decreased according to the existing or obtained data 22.

As illustrated in FIG. 4, another embodiment provides a computer-implemented method 400 of facilitating a negotiation for at least one item or service between a plurality of users. In this embodiment, the method 400 includes the steps of: opening a negotiation event for an item or service (Box 401); initiating one or more offer phases 12 for the item or service (Box 402); setting and displaying an offer price (Box 404); identify and evaluate data 22 received before or during the one or more offer phases 12 (e.g., submission of qualified bids (if any) by one or more users and the acceptance of such bids) (Box 406). Depending on the data 22 received during the one or more offer phases 12, the method 400 further includes one or more of the following steps: adjust the offer phase duration (Box 414), adjust offer price (Box 416), initiate a subsequent offer phase (Box 402), and initiate one or more closing phases (Box 412).

If the step of initiating one or more closing phases (Box 412) is executed, the method 400 may further include the steps of: identify and evaluate data 22 received before or during the one or more closing phases 14 (e.g., submission of qualified bids (if any) by one or more users and the acceptance of such bids during the “going once” closing phase 16) (Box 408). Depending on the data 22 received during the one or more closing phases 14, the method 400 may further include one or more of the following steps: adjust current closing phase duration (e.g., adjust the “going once” closing phase 16) (Box 418), adjust offer price (Box 417), set and display such offer price (Box 405), initiate a subsequent offer phase (Box 402), and initiate additional closing phases (e.g., initiate the “going twice” closing phase) (Box 412).

If the step of initiating additional closing phases (Box 412) is executed, the method 400 may further include the steps of: identify and evaluate data 22 received before or during the additional closing phases 14 (e.g., submission of qualified bids (if any) by one or more users and the acceptance of such bids during the “going twice” closing phase 18) (Box 410). Depending on the data 22 received during the additional closing phases 14, the method 400 may further include one or more of the following steps: adjust current closing phase duration (e.g., adjust the “going twice” closing phase 18) (Box 420), adjust offer price (Box 417), set and display such offer price (Box 405), initiate a subsequent offer phase (Box 402), initiate additional closing phases (e.g., initiate the “going once” closing phase) (Box 412), and initiate a gone phase 20 and close the negotiation event for the item or service (Box 422). Accordingly, and in one preferred and non-limiting embodiment, the first closing phase and subsequent closing phases may be in the form of the “going once” phase 16, the “going twice” phase 18 and then the “gone” phase 20 (as is similar to a live or manual auction process). However, any number of closing phases 14 and gone phases 20 may be utilized, and movement between the phases may be based upon any number of data 22 inputs.

If the step of closing the negotiation event for the item or service is executed, the method 400 may further include the steps of: determine if more items or services are to be negotiated (Box 424). If more items or services are to be negotiated, the system 10 then opens another negotiation event for additional items or services (Box 401). If no more items or services are to be negotiated, the system 10 then closes the entire negotiation event (426).

Continuing with one example of the system 10, when a bidder B submits a qualified bid during any of the phases, the offer price is adjusted (although, as discussed, the offer price may be adjusted based upon a variety of criteria and data 22). However, after moving through the “gone” phase 20, the item or service is closed. At this point, the system 10 checks to see if there is another product or service scheduled to be negotiated. If another item or service is scheduled to be negotiated, the system 10 will compare the actual event schedule to the published pre-event schedule. Based upon some preconfigured or determined rules, the system 10 may dynamically adjust the offer price and duration of each of the phases, such that the actual event schedule will match the published schedule, without substantially sacrificing market pricing for any given item or service. If there are more items or services, the next item or service will be opened. These preconfigured or predetermined rules can be followed during a negotiation or can be modified at any time during the negotiation or during a specific sub-portion of the negotiation. This process is repeated for all products and services in the event. Finally, once all the products and services have been through the negotiation process, the event is automatically closed.

The above-described exemplary embodiments illustrate the initiation of negotiation phases, the adjustment of the phase duration and the adjustment of offer price based upon identifying and analyzing data 22 received before or during the negotiation event for an item or service. As seen by the above steps in this described embodiment, the computer-implemented method 400 enables similar bidding dynamics and negotiation control available in a live negotiation and controlled by a live coordinator or auctioneer A. To this end, the dynamically adjustable offer price and phase-driven approach to an online negotiation provides many benefits ranging from efficiently providing market transparency to achieving the optimal market price.

As discussed above, the method 400, as illustrated in FIG. 4, may be implemented as a system 10 in a network environment N. In the exemplary embodiment of FIG. 2, the system 10 includes a central negotiation system 50, which may be accessible by the bidders B, observers O, as well as the coordinator C over or on the network environment N, e.g., through a website or other similar interface. Accordingly, multiple bidders B can access the real-time auction and/or negotiation process through any standard Internet connection, and the entire event or process can be monitored, managed and/or controlled by the event coordinator C (or remote auctioneer A).

In one embodiment, the negotiation event includes a pre-published event schedule that indicates a suggested start time for each item or service in the event. Like a physical auction event, typically the main goal of the auction (or negotiation) process is to obtain true market value in lieu of following an exact bidding schedule. Accordingly, the bidding schedule is posted as a reference, but as discussed above in detail, the method and system 10 is capable of dynamically adjusting the time period or schedule of the event, the acceptance of “qualified” bids, and the modification of the offer price, all in order to optimize both the market price as well as the published event schedule. This adjustment can take into account the time interval between phases based upon: the timing of the individual bids; and/or the decrement/increment between individual bids.

In operation, the central negotiation system 50 is programmed, configured or adapted to implement the various steps discussed above. Therefore, the central negotiation system 50 is configured or adapted to: (i) enter at least one phase of the negotiation for the at least one item or service; (ii) set an offer price for the at least one item or service; and (iii) dynamically adjust at least one of (i) the duration of the at least one phase and (ii) the offer price for the at least one item or service, based at least in part upon data that is existing or obtained during at least one phase of the negotiation.

To provide for the appropriate communication of data 22 between the bidders B, the observers O, the coordinator C and any other interested party, the negotiation system 10 includes a communication system 52 for facilitating communication between the users, bidders B, observers O, coordinator C, etc. and the central auction system 50. For example, when the event opens, the system 10 may send one or more real-time communications to one or more bidders B that the first product or service is now up for bid. Of course, a variety of other communications are also envisioned between the users of the system 10. In addition, this communication system 52 may be in any known communication architecture and form as known in the art. In particular, the communication system 52 permits the users to communicate and transmit and receive data 22 over the network environment N. Any known network communication technique and process may be used to implement the method and system 10 of the present invention.

In one embodiment and in order to provide the automatic or semi-automatic control of the negotiation process, the central negotiation system 50 includes a rule set 54 that defines one or more parameters of the auction or negotiation process. This rule set 54 is dynamic, adjustable, implemented, automatically implemented, manually implemented, implemented in a combined manual/automatic environment, or any combination thereof. Accordingly, the system 10 may be run in a variety of modes, such as manual, automatic or some hybrid or combination thereof. In one embodiment, the manual mode would constitute an event where an actual live auctioneer A or coordinator C controls the event. The system would provide the appropriate feedback and data to the bidders B, e.g., bid history, schedule status, potential bid information, etc. In addition, the coordinator C would be given the appropriate data and information, e.g., data 22, in order to control the entire event, e.g., offer price, event phases, item closing data, etc. In the automatic mode, and as discussed hereinafter, the event would be totally automatic and the live coordinator C would be replaced by a system-intelligent virtual auctioneer or coordinator. Therefore, the rule set 54 would include the appropriate algorithms and logic to mimic the behavior of a live coordinator C.

In the combination or hybrid mode, a virtual auctioneer A or coordinator C makes automated decisions, however the live auctioneer A or coordinator C may override such decisions and take action if some unplanned or unforeseen circumstances arise. For example, if the event is moving past the allocated schedule, the live event coordinator C can set a parameter to speed up the auction, e.g., 1.5 times the normal speed. While this may reduce the amount of time of each phase in the event, it will assist in better control of the event scheduled. In another example, the live event coordinator C may determine that the event should be paused since a bidder B is having technical difficulty, or in another example, a bid must be removed as it was incorrectly entered by a bidder B in the event.

The rule set 54 may also be used to qualify a bidder B and/or qualify a specific bid of the user or bidder B. As discussed, the central auction system 50 may also (based upon the rule set 54) transmit data 22 to the users, including the bidders B, observers O and the coordinator C. Appropriate data is provided to the bidder B in order to facilitate the arrival at a market price, and appropriate data information is provided to the coordinator C in order to manage control of the event.

As illustrated in FIG. 2, a negotiation user interface 56 may be presented or provided to the bidder B or observer O on the computer D. Accordingly, this negotiation user interface 56 is capable, programmed or configured to display data 22 received, stored, processed or transmitted from the central negotiation system 50. Further, the bidder B may use the negotiation user interface 56 to input or communicate bids to the central negotiation system 50, as well as communicate with the coordinator C. Therefore, the negotiation user interface 56 is an interactive interface for presenting data to the bidder B and accepting and communicating input data from the bidder B. Still further, this negotiation user interface 56 is fully or partially configurable by the user, such as the placement of data 22 on the computer D and interface 56, the display of chosen data points, the display of historical bid data, etc. This negotiation user interface 56 may also include various tools for use by the bidder B in making decisions regarding the item or service up for bid, e.g., calculators, algorithms, charts, trend analysis tools, etc. In addition, any of the data 22 may be selectively provided, processed or displayed to the bidder B or observer O, based either upon a request or a rule in the rule set 54.

During the event, the negotiation user interface 56 may display one or more indicators to the user indicating at least one aspect or parameter of the negotiation. This indicator may be a visible indication, an oral indication, an audible indication, a color, a sound, flashing graphic, etc. As discussed hereinafter in connection with an indication area 40, indicators may allow the bidder B to understand in which phase the auction process is entering or residing. In one example, colors are used to indicate the phase, e.g., a yellow indicator for the “going once” phase 16 and a red indicator for the “going twice” phase 18. Of course, any appropriate indication of data 22 to the bidder B to facilitate the negotiation process can be used. As set forth above, the actual phase or status of the phase may be directly indicated to the bidder B for use in making decisions regarding placing bids. Further, other data 22 may be provided to the bidder B for making appropriate decisions during the negotiation process.

As discussed, the central negotiation system 50 is programmed to include the appropriate rule set 54 in order to engage in the appropriate actions, whether automatically or as directed by a live coordinator C. For example, the central negotiation system 50 may adjust the phase duration and/or the offer price based upon various data points in the data 22, whether existing data or data obtained during the negotiation process. For example, the central negotiation system 50 may adjust the phase duration, i.e., the phase, and/or the offer price based upon at least one bid submitted by a user or bidder B. As discussed, the phase duration and/or the offer price may be set or adjusted dynamically, automatically and/or manually.

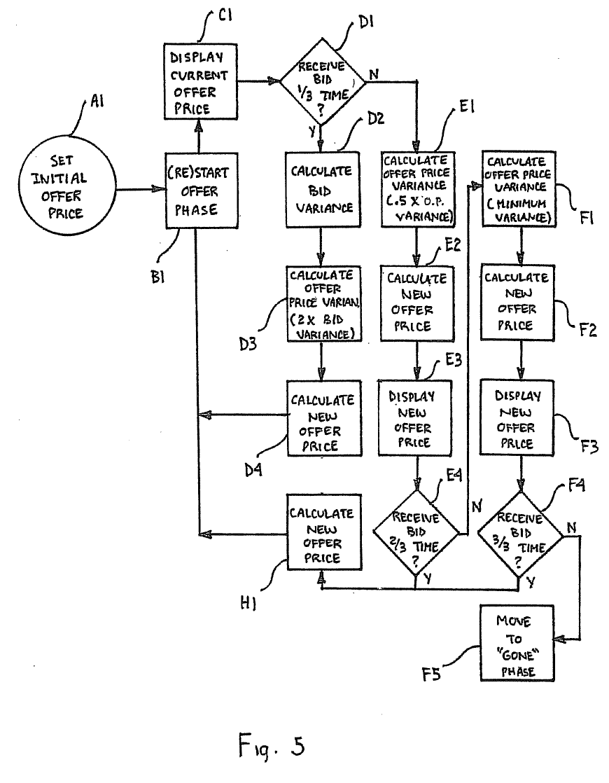

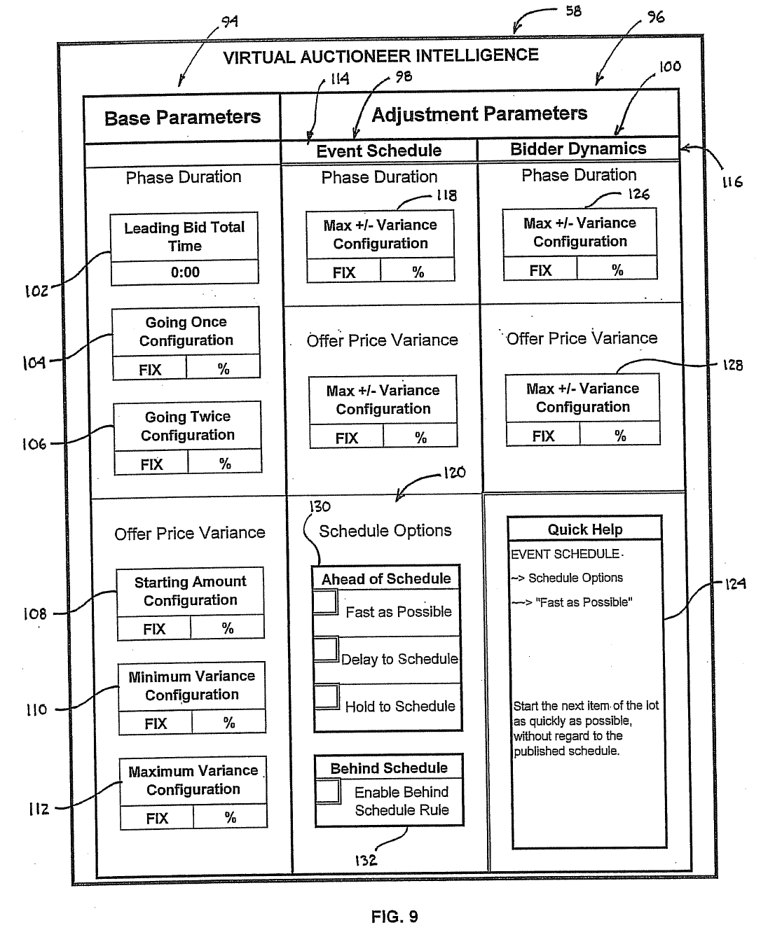

FIG. 5 illustrates one exemplary embodiment of the system 10 regarding modifying the offer price to stimulate a first or subsequent bid during the offer and/or closing phases of a negotiation. In this embodiment, the offer price is adjusted based upon time data 28 and bid data 24. First, an initial offer price is calculated by adjusting the starting price by the offer price variance, wherein the offer price variance is initially set to the “starting offer price variance” 108 (see FIG. 9). In one embodiment, the starting price may be a bid ceiling, bid floor, historic price, paper bid, etc. and the starting price variance 108 (FIG. 9) may be set either as a fixed monetary amount or a percentage of the starting offer price of the item (Box A1), after which, the offer phase 12 begins (Box B1). The current offer price is then displayed to the bidders B (Box C1), and if a bid is received within a specified time period (e.g., within five (5) minutes of displaying the offer price or within one-third (⅓) of the total time allowed for a leading bid) (Box D1), the system 10 calculates the bid variance (Box D2).

When no leading bid exists, the bid variance is the difference (or delta) between the starting price and the most recently submitted bid; however, after a leading bid exists, the bid variance is the difference between the leading bid and the most recent leading bid submitted (Box D2). The system 10 may then calculate an offer price variance by multiplying the calculated bid variance by a specified factor (e.g., two times the bid variance or double the bid variance) (Box D3). When calculating the offer price variance, the system 10 may also determine if the offer price variance is within a range of a minimum and maximum offer price variance allowed (110 and 112 respectively) (see FIG. 9). If the offer price variance is greater than the offer price variance range allowed, the offer price variance is set to the maximum offer price variance (112) allowed, and if the offer price variance is less than the offer price variance range allowed, the offer price variance is set to the minimum offer price variance (110) allowed (Box D3). A new offer price is then calculated by adjusting the most recent leading bid submitted by the offer price variance (Box D4). The system 10 then re-initiates the offer phase (Box B1).

If a bid is not received within a specified time period (e.g., within five minutes of displaying the offer price or within one-third (⅓) of the total time allowed for a leading bid) (Box D1), the system 10 may then calculate a new offer price variance by multiplying the current offer price variance by a specified factor (e.g., 0.5 times the current offer price variance) (Box E1). When calculating the new offer price variance, the system 10 may also determine if the new offer price variance is within the range of a minimum and maximum offer price variance allowed (110 and 112 respectively) (see FIG. 9). If the new offer price variance is greater than the offer price variance range allowed, the new offer price variance is set to the maximum offer price variance (112) allowed, and if the new offer price variance is less than the offer price variance range allowed, the offer price variance is set to the minimum offer price variance (110) allowed (Box E1). A new offer price is then calculated by adjusting the most recent leading bid submitted by the new offer price variance (Box E2).

In the case where no leading bid exists, the new offer price is then calculated by adjusting the original starting price by the new offer price variance (e.g., for a reverse auction, the new offer price would be increased by the new offer price variance, and for a forward auction, the new offer price would be decreased by the new offer price variance to stimulate bidding) (Box E2). The new offer price is then displayed to the bidders B (Box E3). If a bid is received within a specified time period (e.g., within five minutes of displaying the new offer price or within two-third (⅔) of the total time allowed for a leading bid) (Box E4), a new offer price is calculated by adjusting the most recent leading bid submitted by the offer price variance calculated in Box E1 above (Box H1). The system 10 then re-initiates the offer phase (Box B1).

If a bid is not received within a specified time period (e.g., within five minutes of displaying the new offer price or within two-third (⅔) of the total time allowed for a leading bid) (Box E4), the system 10 may then set the current offer price variance to the minimum offer price variance 110 (see FIG. 9) (Box F1). A new offer price is then calculated by adjusting the most recent leading bid submitted by the offer price variance calculated in Box F1 above (Box F2). Where there is no leading bid, the new offer price is then calculated by adjusting the original starting price by the offer price variance calculated in Box F1 above (Box F2). The new offer price is then displayed to the bidders B (Box F3). If a bid is received within a specified time period (e.g., within five minutes of displaying the new offer price or the total time allowed for a leading bid) (Box F4), a new offer price is calculated by adjusting the most recent leading bid submitted by the offer price variance calculated in Box F1 above (Box H1). The system 10 then re-initiates the offer phase (Box B1). If a bid is not received within a specified time period (e.g., within five minutes of displaying the new offer price or the total time allowed for a leading bid) (Box F4), the system 10 initiates the “Gone” phase 20 (Box F5). Again, this illustrates only one embodiment of adjusting the offer price based upon specific data 22 obtained during the bidding process, where this offer price is dynamically adjusted to encourage bidders B to bid and arrive at a reasonable market value.

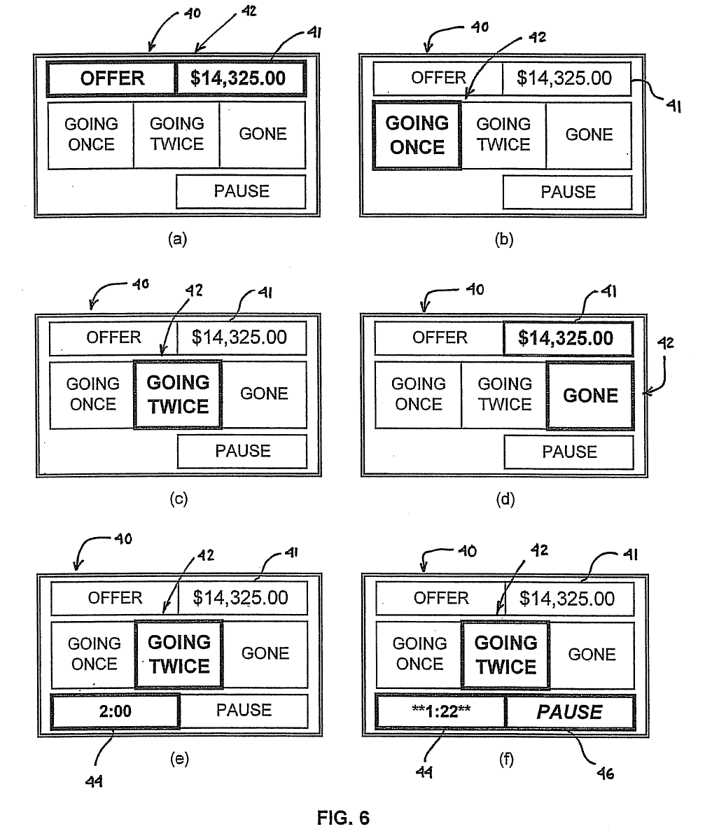

In combination with dynamically adjusting the duration of the phase and/or the offer price, and to facilitate the negotiation process, FIG. 6 illustrates an embodiment of the system 10 of the present invention, which provides some visual indication area 40 to the bidder B, coordinator C, or observer O on the display of the computer D. This indication area 40 would include basic indicators 42 of the status of the negotiation, including which phase the negotiation is being implemented, as well as the offer price 41. As illustrated in FIG. 6(a)-(d), the bidder B has access to the indication area 40 which identifies the current negotiation phase and the offer price 41. FIG. 6(a) provides an indication that the negotiation is in the offer phase 12, FIG. 6(b) indicates that the negotiation is in the “going once” phase 16, FIG. 6(c) indicates that the negotiation is in the “going twice” phase 18, and FIG. 6(d) provides an indication that the negotiation is closed, or in the “gone” phase 20. As discussed, this indication area 40 may visually display or provide some other indication of the current (market leading) offer price 41 or bid. Of course, the current or pending offer price or bid may be communicated to the bidders B in a variety of display areas and manners.

As seen in these indication areas 40, the bidder B would have no concept of how much time is left in each phase, which would be determined either automatically or semi-automatically by the system 10, or by the coordinator C. Accordingly, either the system 10 would modify the phase duration (as well as the offer price) in an automated mode (as discussed hereinafter), or the coordinator C could adjust phase duration and/or offer price in response to existing or obtained data 22 via a control interface, as also discussed hereinafter. This means the bidder B could not wait until a certain time prior to the closing of a phase or adjustment of an offer price to place their bid, as the bidder B would not understand when the phase will change, or when a new offer price will be set. This mimics a true, physical auction, where the auctioneer A will not permit bidders B to “game” the system by waiting for an advantageous time to place a given bid.

In FIG. 6(e), a time indicator 44 (e.g., clock) provides some insight into the time change prior to any dynamic adjustment. While, as stated, this provides the bidder B with some general knowledge regarding the time left in a given phase, in a preferred embodiment, this clock 44 does not simply count down to zero, and instead can be dynamically adjusted as the phase duration is adjusted based upon the data 22. Further, this clock 44 may indicate the estimated time within the negotiation, the estimated time within any given and specified phase and/or an estimated time range within the negotiation and/or any given and specified phase.

In FIG. 6(f), a pause indicator 46 is provided showing that the negotiation was paused in the “going twice” phase 18. If there is a clock, this clock will also pause. There are a variety of reasons that the coordinator C (or the system 10 automatically) will pause the negotiation, such as the occurrence of unforeseen circumstances that meet a specified rule, issues with communication, issues with one or more of the bidders B, issues with qualification information or a specific bid, etc. In any case, in the indication area 40, the “pause” status of a negotiation would be provided to all bidders B.

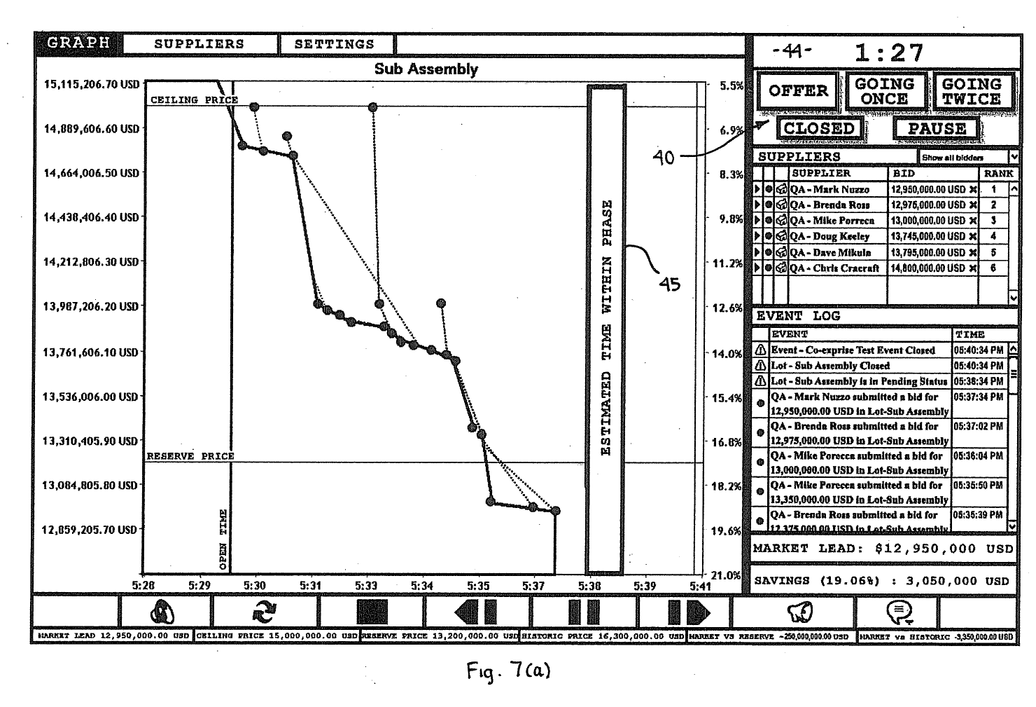

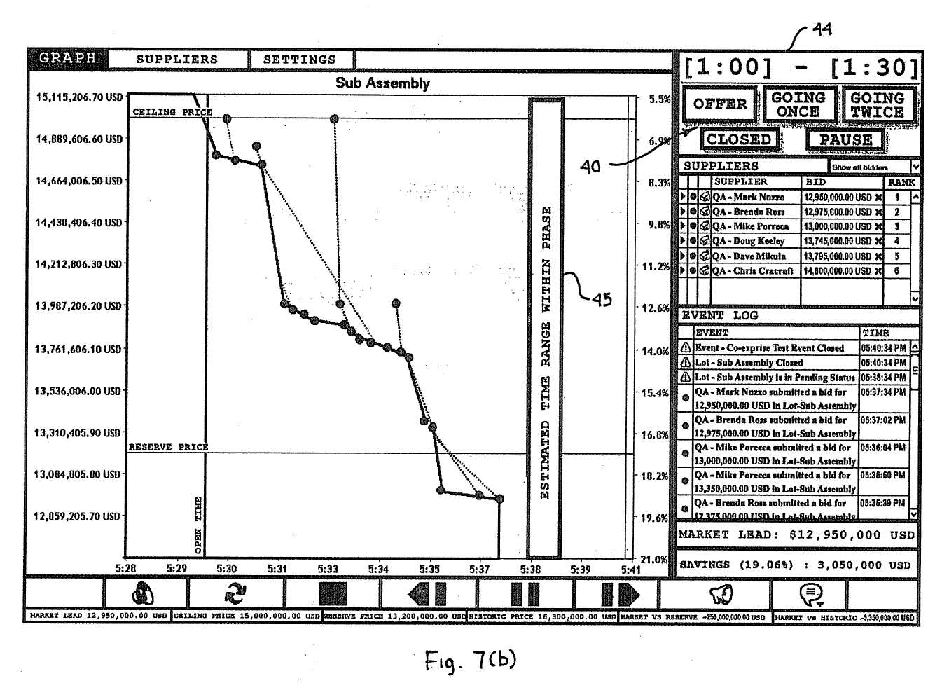

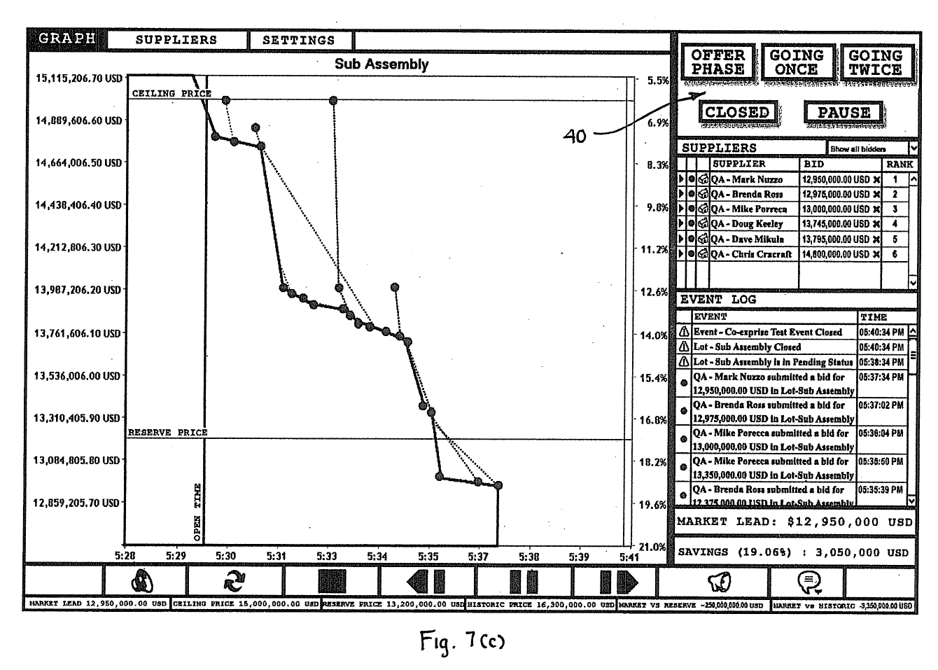

Together with the above-discussed indication area 40, FIG. 7 illustrates a series of exemplary screen shots of a bid graph showing the progress of the negotiation to the bidder B, coordinator C, or observer O on the display of the computer D. In particular, FIG. 7(a) illustrates the use of an indication area 40 that identifies the phase, whether the negotiation is paused and includes a clock 44 providing the estimated time within the phase. FIG. 7(b) illustrates the use of an indication area 40 that identifies the phase, whether the negotiation is paused and includes a clock 44 that provides a time range within the phase. In both of these examples, a visual bar 45 is included that corresponds to the estimated time or time range on the clock 44. FIG. 7(c) demonstrates the use of an indication area 40 that does not include a clock 44 or other related time indicator 44, instead graphically representing the current phase only. Further, it should be noted that additional information would be available to the coordinator C regarding the phase, the time remaining in a phase and other data that permits the coordinator C to make appropriate control decisions during the negotiation process.

When used in an online or network environment N, data is transmitted to or presented to the users, i.e., the bidders B, the coordinator C, the observers O, dependent upon the user's role in the event. In addition, the method allows for the effective tracking (and storage) of various data points before, during or after the negotiation event. Such data points may include any of the data 22 in any of the exemplary categories discussed above. Therefore, the method allows for the effective real-time communication and transmission of data over the network environment N to the user's computer D, and subsequently to the viewer or user (bidder B, observer O and/or coordinator C).

As discussed, the present invention provides for the implementation of a physical auction process in the context of an automated online environment. In one example, and during the offer phase 12, the item (or service) is opened, and based upon some predefined, automated rule set or on a remote auctioneer A or coordinator C computer D, the system 10 will display or present an initial offer price to the potential bidders B. Any of the bidders B are now in a position to submit a qualified bid. In this example, the definition of what will be considered a “qualified” bid in a negotiation event is determined prior to the event by the coordinator C or the entity conducting the negotiation event. For example, a “qualified” bid is a bid that is higher than the previous market leading bid in a forward auction. In another example, the “qualified” bid is a bid that is lower than the previous market leading bid in the case of a “reverse” auction. It is this best “qualified” bid that establishes a market leader for that product or service. A market leader will hold this lead position until another bidder places a better “qualified” bid before the “gone” phase 20. According to the automated embodiment of the present invention, every qualified bid may reset the phase back to the offer phase.

According to another embodiment, the bidding process may appear to slow or stop in the offer phase 12. At this point, the remote coordinator C or the system 10 (in an automated routine) may either broadcast a new offer price to the bidders B (based upon the data 22), or alternatively, set the phase to the “going once” phase 16. Once in the “going once” phase 16, each bidder B may see some indication that this item or service is entering this particular phase, in the indication area 40. If a qualified bid is received in the “going once” phase 16, the system 10 may automatically or manually revert back to the offer phase 12. However, if no new qualified bids are placed in the “going once” phase 16, the remote coordinator C or system 10 may place the item or service phase to the “going twice” phase 18. Each of the bidders B will be notified of this phase in the indication area 40. If a qualified bid is received during this “going twice” phase 18, once again, the system 10 may automatically or manually set the phase back to the offer phase 12. Once the remote coordinator C or system 10 (based upon the lack of additional qualified bids) determines the product or service is at best market price, the phase is set to the “gone” phase 20.

It should be recognized that the remote coordinator C or system 10 will have the ability to re-open an item or service based upon a variety of data 22 existing or obtained during the negotiation and/or the existence of some uncontrollable event, e.g., bidder B technical difficulty and/or invalid bid. The system 10 will allow the remote coordinator C or system 10 to broadcast (in real time) a message to all bidders B regarding the event, as well as the actions each bidder B must take to overcome this unplanned issue. As discussed, a “pause” indication 46 may be provided in the indication area 40 to all bidders B. It should also be recognized that bidders B can send real-time messages or questions to the remote coordinator C or other system controller. It should be further recognized that the presentation of all data 22 over the network environment N to the user's computer D (bidder B, coordinator C, observer O) may take place in real time with or without requiring users to refresh the screen or display of the computer D. Accordingly, this data 22 may be “pushed” to or “pulled” from the user's computer D.

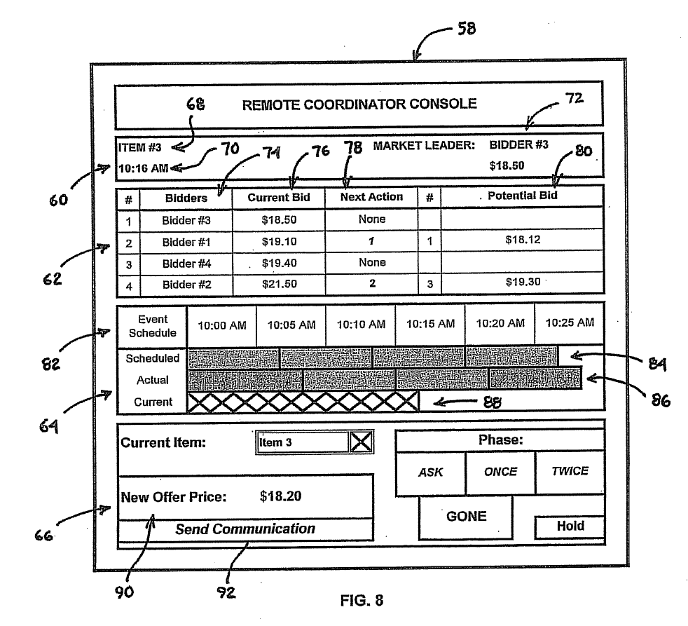

In order to provide the appropriate control to a live coordinator C, and as illustrated in FIG. 8, a negotiation control interface 58 may be provided to a control user or coordinator C. This negotiation control interface 58 is capable of displaying data 22 received, stored, processed or transmitted from the central negotiation system 50. Further, this data 22 may be displayed to the coordinator C on the coordinator's computer D.

In one embodiment, and as illustrated in FIG. 8, the negotiation control interface 58 includes multiple areas or portions for presenting data 22 to the coordinator C in an organized and usable format. In addition, this data 22 may be selectable, sortable, dynamic, modifiable, automatically provided, manually provided, static, indicated, etc. In order to allow for the appropriate interaction between the coordinator C and the negotiation control interface 58, the interface 58 may include one or more selectable elements permitting data input from the coordinator C to the central negotiation system 50 through the negotiation control interface 58. For example, the selectable element may be a menu, a drop-down menu, a radio button, a selectable button, an action button, a text-entry box, etc. In this manner, the negotiation control interface 58 allows for the appropriate input and output of data for the coordinator C to use in managing and controlling the process.

In the exemplary embodiment of the negotiation control interface 58 illustrated in FIG. 8, the interface 58 or console provides the coordinator C with past, present and/or future event (or negotiation) inputs in various categories, and further allows the coordinator C to control the event by providing functionality to perform various actions, e.g., set or dynamically adjust the offer price, the phase, communicate with bidders B, manage unplanned events, etc. In the exemplary embodiment of FIG. 8, the negotiation control interface 58 includes a summary area 60, a bid activity area 62, an event schedule area 64 and an event control area 66. In this embodiment, the summary area 60 includes or presents specified item data 68 (or service data), summary data, time data 70 and leading bid data 72, e.g., leading user or bidder data, leading price data, etc.

The bid activity area 62 also presents specific data to the coordinator C. For example, the data may include user data, bid data, current bid data, next action data, bid or intent data, potential bid data, bid history data, bid order data, bid placement data, bid detail data, bid entry data, bid submission data, indication data, intention data, bid qualification data, bid leader data, bid ranking data, etc. In the example of FIG. 8, the bid activity area 62 provides bidder data 74, current bid data 76, next action or bidder intent data 78 and potential bid data 80. Accordingly, this bid activity area 62 may indicate each bidder's best bid. In this example, the order of the grid is based on best-to-worse bids, followed by bidders B who have not placed a bid. Each line may be expanded to show the details of every bid for a given bidder B, such that the coordinator C may understand the user's bid history and associated trends. In addition, in such an expanded view, it is envisioned that the coordinator C can remove an invalid bid. In addition, the coordinator C may also remove a specific bidder B from the event or particular item or service being negotiated.

In this embodiment, the bidder data 74 displayed to the coordinator C presents either the company and/or the real name of the user (or possibly some alias) depending upon the parameter set for the negotiation process. The current bid data 76 includes the bidder's last or best bid. The next action or bidder intent data 78 provides some indication of bidder interaction or intended interaction with the system 10, as discussed above in detail. This data and area may be configured based upon various event rules to not show this next action or bidder intent data 78, to show a count only of how many bidders B are ready to place a bid, provide some indicator only for each bidder B, color code the bids as to whether or not it is a qualified bid or a market leading bid, etc.

In one example, and with continued reference to the next action or bidder intent data 78, a green indicator may be used for a market leading bid, while a qualified (but not market leading) bid may be shown in yellow. Other pre-bids may be shown in red. This area or next action or bidder intent data 78 may also provide some indication as to the bid ranking based on current bids in the marketplace. This data is fully configurable, and may be displayed to the coordinator C in any chosen or logical format. The potential bid data 80 indicates the amount currently on the bidder's negotiation user interface 56, but which has not yet been submitted. Of course, as discussed above, this column or area may be configured to not show any values based upon the event parameters in the rules of any particular event.

As illustrated in the exemplary embodiment of FIG. 8, event schedule area 64 may include time data, schedule data, event schedule time data, tracking data, actual event time data, actual negotiation time data, current event time data, current negotiation time data, indication data, intention data, negotiation identity data, current time data, etc. For example, in this embodiment, the event schedule area 64 is an indication of how the actual schedule is tracking to the pre-event published schedule. Event schedule data 82 may be provided as a header row illustrating time increments based upon the entire event schedule. In this example, there are four items with a planned time of seven minutes each, totaling 28 minutes for the event (as indicated by the event schedule data 82). The four items are indicated as scheduled data 84 in block or row form.

A next row indicates actual event data 86 in row form beginning with when an item or service was opened for bid. In this example, the first item was open for bid for approximately nine minutes. Since it was over the allotted seven minutes, this block or row portion is indicated in a different color, e.g., red. Another color, e.g., green, may indicate those items that were open less or equal to the allotted time. In addition, a blue indicator may be used for those items that are currently open, while a gray indicator may be used for items that are scheduled for later in the event (or have yet to be opened). Finally, the current time data 88 displays a progress bar or row based upon the current local time.

Continuing with the exemplary embodiment of FIG. 8, the event control area 66 may include a variety of selectable elements 90 permitting data input from the coordinator C to the central negotiation system 50 via the negotiation control interface 58. For example, in the event control area 66, the coordinator C may remove a bid, remove a user or bidder B, select an option, select an event, input or adjust an offer price, select or adjust a negotiation phase, i.e., choose phase duration, close the negotiation, place the negotiation on hold, broadcast data, etc. Further, the coordinator C may use a “send communication” button 92 in the event control area 66 to send one or more communications or messages to one or more of the users. In the illustrated example, the coordinator C may select an item (or service) of which he or she is interested in viewing data through the use of a drop-down menu or radio button. Further, the coordinator C may manually or automatically enter or adjust the offer price, wherein such inputs are dynamically executed based upon data 22 that is existing or obtained during a phase of the negotiation. Still further, the coordinator C may manually or automatically adjust the duration of a phase or in which phase the negotiation process is to be placed, e.g., the offer phase 12, the “going once” phase 16, the “going twice” phase 18, the “gone” phase 20, etc., again wherein such inputs are dynamically executed based upon data 22 that is existing or obtained during a phase of the negotiation. In addition, in this event control area 66, the coordinator C may place the event, item or service on hold.

As discussed, and with continued reference to the event control area 66 of this embodiment, the coordinator C is capable of controlling a global negotiation event from his or her computer D. The coordinator C has the ability to select or re-select the current item for bid by selecting the item or lot from a selection list. Based upon the event parameters, the system 10 may calculate a new offer price for the open item. The coordinator C may accept this value, or alternatively enter in a new value to be communicated real-time to all the bidders B. Further, the coordinator C may easily select or change the current phase for an item which instantly changes the status in all the negotiation user interfaces 56 on the bidders' computers D. In this embodiment, the system 10 may automatically set the phase of the item or service to the offer phase for each qualified bid. If an unplanned issue occurs in the event, the coordinator C may place the event on hold, which would suspend all bidding activity until the event is resumed. Still further, once the coordinator C feels like the best market price has been reached for the item or service, this decision may be broadcast to all bidders B by selecting or moving the phase to the “gone” phase 20. Of course, any of the appropriate data points or fields of the data 22 may be displayed to the coordinator C and used in making decisions regarding how to control and implement the negotiation. The above-discussed data points are only exemplary and in no way should be construed as limiting the use or operation of the negotiation control interface 58.

As discussed above, while such a negotiation control interface 58 may be used, the method may be implemented in a fully automated fashion based upon a definable rule set 54, which allows for the control of the event or auction by a virtual coordinator C. After appropriate definition and setting of the rules for the negotiation, the method, according to this embodiment, is implemented by the system 10 in a substantially fully automatic mode. The rule set 54 may be defined or implemented via an automated negotiation control interface 58.

One embodiment of the automated negotiation control interface 58 is illustrated in FIG. 9. In this embodiment, the system 10 is automated and configurable to make appropriate decisions similar to a manual auctioneer A or coordinator C. Since each negotiation is different, appropriate data 22 must be supplied to the system 10 in order to appropriately make decisions based upon the resulting rule set 54, and in order to achieve true market price while minimizing the time (or holding to a schedule) of the event duration. In this embodiment, there are two basic categories of parameters that, when provided or entered into the system 10, result in a rule set 54 that will allow the system 10 to make the correct decisions throughout the event process. These two categories of configurable inputs include base parameters 94 and adjustment parameters 96.

In this preferred and non-limiting embodiment, the first category of parameters that is adjustable at the negotiation control interface 58 is the base parameters 94. These parameters 94 serve to set up the base line for the event and, in this embodiment, are configured on an event-by-event basis. As illustrated in FIG. 5, these base parameters 94 (or rules) drive the decision-making process. For example, in the exemplary embodiment of FIG. 5, when a bid is received in one third of the total time allowed for the leading bid, the bid variance is doubled. The parameters 94 used to set the time to one third, to double the variance and to check if it exceeds the maximum allowable variance are all examples of base parameters 94.

The second category of configurable parameters is referred to as adjustment parameters 96, which are those configurable inputs that affect or modify the rules or base parameters 94. Further, like the base parameters 94, and as discussed hereinafter, these adjustment parameters 96 can be expressed in terms of a fixed value or a percentage change with respect to the base value. For example, in FIG. 9, two examples of adjustment parameters 96 are event schedule parameters 98 and bidder dynamics parameters 100. The event schedule parameters 98 are configurable inputs based upon the published, current, projected or estimated event schedule, while the bidder dynamics parameters 100 are configurable inputs based upon data 22 such as bid data 24, bidder intent data 26, etc.

In one non-limiting embodiment, the adjustment parameters 96 are optional, and are not required in the “lights out” or any automatic mode. Instead, the system 10 is operated based only upon the base parameters 94, as in, for example, the exemplary embodiment of FIGS. 4, 5 and 6. However, when used, the adjustment parameters 96 allow for additional flexibility and functionality for maximizing event efficiency (both as to price and schedule). In operation, first the base parameters 94 are calculated and/or set, and the adjustment parameters 96 or rules are set to adjust various parameters based upon the set base parameters 94 and incoming, dynamic data 22. For example, where the system 10 doubles the offer price variance when a bid is received within one third of the offer phase 12 time, an event schedule parameter 98 or rule can be set to triple the offer price variance if the event is running behind schedule, plus decrease the duration of each phase (12, 14, 20) by 20%.

With specific reference to FIG. 9, the automated negotiation control interface 58 includes two sections directed to the two categories of configurable parameters 94, 96 that lead to the rule set 54 for implementing the event. Further, the section referring to the adjustment parameters 96 is further separated into a section for the event schedule parameters 98 and a section for the bidder dynamics parameters 100. Still further, and as discussed in detail above, the two primary and dynamically-adjustable parameters are phase duration (e.g., determining when the system 10 changes the phases or phase duration) and offer price, and the rule set 54 stems from modifying these values as base parameters 94 and/or the adjustment parameters 96.

First, with respect to the base parameters 94 (which are used as a base line for the event), the leading bid total time 102 is set and represents the initial phase duration. In one example, the phase duration may be set to a two-minute interval for each new lead and qualified bid. In such an example, if a bid is received during the two-minute interval, the system 10 re-initiates the offer phase 12 which will allow the current leading bid to remain the leading bid for the time set by the base parameter 102 (e.g., two minutes), wherein such base parameter 102 is dynamically adjustable by adjustment parameters 96 as described hereinafter. If new bids are not received in this time frame, the item or lot would be closed (e.g., gone phase 20) or moved to a closing phase 14. Further, in this example, and based upon this two-minute interval, the next configured parameter would be the “going once” phase 16, and the parameters associated therewith as provided in the “going once” configuration portion 104. In this embodiment, this parameter 104 can be set to a percentage, e.g., 50%, of the leading bid total time 102, i.e., the two-minute interval. Of course, this parameter 104 could also be set to a fixed amount (e.g., one minute), wherein this base parameter 104 is dynamically adjustable by adjustment parameters 96 as described hereinafter.

One difference between setting the “going once” configuration portion 104 to 50% of two minutes versus a fixed rate of one minute is how the “going once” phase 16 varies when the total interval varies. For instance, if the coordinator C sees that the event is running behind the estimated schedule, they may vary the two-minute leading bid total time 102 to one minute and thirty seconds. In the first case, i.e., setting the “going once” configuration portion 104 to 50%, the “going once” phase 16 duration would be forty-five seconds (50% of one minute and thirty seconds). In the other case, the duration of the “going once” phase 16 would remain at one minute. The rules for implementing the “going twice” phase 18 are set at the “going twice” configuration portion 106. These rules may be configured similarly to the “going once” configuration portion 104, with the exception that it should be understood that these parameters may also be based on a percentage of the “going once” phase 16, as well as the overall interval for a leading bid total time 102.

The next base parameter 94 that is set is the offer price variance amount, which is configured at the starting amount configuration portion 108, the minimum variance configuration portion 110 and the maximum variance configuration portion 112. At the starting amount configuration portion 108, the variance amount is initially set as either a fixed monetary amount or a percentage of the starting price of the item. At the minimum variance configuration portion 110, the minimum variance amount is set as either a fixed monetary value or a percentage of the starting variance amount determined at the starting amount configuration portion 108. Similarly, at the maximum variance configuration portion 112, the maximum variance amount is set as either a fixed monetary value or a percentage of the starting variance amount determined at the starting amount configuration portion 108.

The next area of the negotiation control interface 58 of this embodiment is used to configure the adjustment parameters 96, and includes an event schedule configuration portion 114 directed to the event schedule parameters 98, and a bidder dynamics configuration portion 116 directed to the bidder dynamics parameters 100. These sets of parameters 98, 100 define how the system 10 will vary from the base parameters 94 and configurations under different conditions. The configuration of the adjustment parameters 96 represents the building of a rule set 54 that is implemented to dynamically adjust the phase duration and/or the offer price based upon received data 22.

Under both the event schedule configuration portion 114 and the bidder dynamics configuration portion 116, configuration of the variance of the phase duration parameter (or leading bid total time 102) occurs at the phase duration variance configuration portion 118, and configuration of the variance of the offer price parameters occurs at the offer price variance configuration portion 120. In the phase duration variance configuration portion 118, the event schedule parameters 98 are adjusted with respect to the base and according to whether or not the event is on, behind or ahead of schedule and the specified goals of the user. In the offer price variance configuration portion 120, the bidder dynamics parameters 100 are adjusted with respect to the base and based upon bid data 24, bidder intent data 26, etc. At both the phase duration variance configuration portion 118 and the offer price variance configuration portion 120, the value, e.g., time value or monetary value, is set either at a fixed value or a percentage value.

As illustrated in FIG. 9, and under a schedule options portion 122, the user can specifically select a goal for the event at that particular moment, or on an event-by-event basis. In one embodiment, the schedule options 122 may include “Ahead of Schedule” options 130 and “Behind Schedule” options 132. Accordingly, the phase duration and offer price will be adjusted by a rule set 54 developed to achieve a selected goal, e.g., fast as possible, hold to schedule, delay to schedule, etc. According to this embodiment, the “Ahead of Schedule” schedule options 130 may only apply if the event is running ahead of schedule, such that if the event is on schedule, and all other factors are equal, the system 10 would utilize the base parameters 94 and not the “Ahead of Schedule” options 130. For example, if the system 10 is configured to run the event “as fast as possible” under the “Ahead of Schedule” options 130, the system 10 would immediately open the next item or lot as soon as the current item or lot closes, without regard to the published schedule. Accordingly, the system 10 would not add any delays to the event or apply any rules that may slow the event to match a published schedule. However, if “delay to schedule” is selected under the “Ahead of Schedule” options 130, the system 10 will still immediately open the next item or lot as soon as the current item or lot closes (same as the “fast as possible” option), but will increase the phase duration and/or adjust the offer price in an attempt to achieve the published or set schedule. However, the published schedule may not necessarily be realized and the subsequent bid item/lot will still open ahead of schedule. Finally, if “hold to schedule” is selected under the “Ahead of Schedule” options 130, the system 10 will operate the same as “delay to schedule” except that the subsequent item/lot will open at the published scheduled time regardless of the actual time that the previous lot/item closed.

In another embodiment, the system 10 may not enable or utilize any of the “Ahead of Schedule” options 130 and associated rules, but may utilize the “Behind Schedule” options 132 when an event is running behind schedule. According to this embodiment, the system 10 may vary the offer price and/or the phase duration based on the event schedule configuration portion 114 in an attempt to achieve the published schedule when an event is running behind schedule.

In yet another embodiment, the parameters and rules associated with the bidder dynamics configuration portion 116 are based upon bid data 24, bidder intent data 26, etc. similar to the event schedule configuration portion 114. Based upon bid data 24 (e.g., bid content, offer price, bid-to-bid variance, quantity of bids, quantity of a specific bidder's bids, bid value, etc.) the system 10 can adjust the phase duration utilizing the phase duration variance configuration portion 126 and/or the offer price utilizing the offer price variance configuration portion 128. Further, since the system 10 can, for example, identify when a bidder B is ready to place their next bid (much like an auctioneer A can see if a bidder B is deciding to raise a flag), the system 10 has an indication that bids are ready to be submitted. Based upon the content of these “intended” bids, it can be determined if any would be a market leading bid, a qualified bid, the total quantity of bidders B ready to submit a bid, whether no bids are being prepared, etc. Accordingly, the system 10 may vary the offer price and/or phase duration based upon any one or more of these factors.

With continued reference to FIG. 9, the interface 58 may include a help portion 124 that provides assistance to the user while configuring the various base parameters 94 and adjustment parameters 96 in the appropriate portions. For example, the user may move his or her mouse to hover the pointer over a portion or section of the display, and a definition or explanation of that portion of the interface 58 or specific section on the display would be presented to the user. Of course, any manner of similar assistance or help could be provided to the user, as is known in the art.

Accordingly, the method and system 10 of the present invention may be used in both a manual or semi-automated architecture, as well as in an entirely and substantially automatic mode. When using the negotiation control interface 58, the coordinator C may manually modify and manage the negotiation event based upon the data 22. Alternatively, when using the automated negotiation control interface 58, the system 10 can be run in a “lights out” mode, where the appropriate parameters are set to allow the system 10 to dynamically adjust the phase duration and/or the offer price based upon the existing and incoming data 22.

As set forth above, the system 10 may be implemented in a variety of modes, e.g., coordinator C driven, fully automated or some hybrid mode, where the negotiation is automated with the coordinator C overwriting system actions. In the coordinator C driven mode, and as discussed above, various data points may be considered during the negotiation process. In one example, the coordinator C considers the rate of bids received, and feedback is given to the coordinator C in terms of a current graph with all bids and a timeline of these bids. The coordinator C also considers the value of the bids received, and the feedback is given to the coordinator C in terms of a current graph with all the bids having rollover text with detailed amounts. The quantity of bids received is understood by the coordinator C based upon feedback showing all the bids on the graph, the coordinator C also may consider bidder intent data 26, time data 28 and other data 22 for modifying the offer price, changing the phase duration, closing the item, etc.

In the fully-automated mode, the system 10 considers the rate of bids received, value bids received, quantity of bids received, bidder intent data 26, time data 28, and other data 22 (discussed above) for making automated decisions based upon a modifiable rule set 54. Finally, in a hybrid mode, the combination of the coordinator C driven function and the automated function is implemented. In this embodiment, the system 10 is running in an automatic state, but the coordinator C is also given the same feedback such that the coordinator C can override the system 10. For example, the coordinator C may decide that the event is moving too slowly, and move to the “going twice” phase 18 sooner than the system 10 would, based upon the rule set 54.

As discussed above, the method and system 10 of the present invention allows for the variance of phase duration and offer price based upon a variety of factors and data points, such that these important variables could be dynamically adjusted during the negotiation process. One example of an algorithm that may be implemented to adjust the phase duration is as follows. If there are “X” number of bidders remaining, and there have been “Q” number of qualified bids, and the percentage decrease is “D”, the duration of the offer phase may be shortened to “Z”. In this implementation, the standard duration of the offer phase is sixty seconds, but the bidding is “dragging on” between the final two bidders B. The system 10 allows for the detection of this circumstance, and simply decreases the duration of the offer phase 12 to fifty seconds, then to forty seconds, thirty seconds, etc. The following algorithm may be used for this example: if (X<3) and (Q>10) and (D<0.05%), then (Z=Z−10 seconds). In this example, if out of a total of six bidders B, only two bidders B are actively bidding and there has already been at least ten qualified bids, and the percentage of change from the leading bid is under 0.05% of the total price, then the offer phase 12 duration is decreased by 10 seconds for each leading bid. This would drive the bidders B to bid at a higher rate or speed up the time at the current bid rate. Accordingly, the effective market price would be arrived at much sooner than otherwise.

In this manner, the method and system 10 allow for the effective arrival at a market price for an item or service while minimizing the cost to obtain this market price. This is accomplished by leveraging the key benefits from both a traditional manual and current electronic negotiation process, as one of the main benefits of the manual negotiation is the ability for an auctioneer A to drive the price based on focusing on a particular item and adjusting the phase duration and/or offer price based on an understanding of the bidder dynamics of the given audience, e.g., last bid, audience reaction, overall schedule constraints, etc. The benefits provided from an electronic negotiation architecture is the global real-time reach, while eliminating travel time and cost.

The presently-invented method and system 10 allow for the real-time negotiation that allows the bidders B to focus on the market price by eliminating the bidder's ability to “game” the system based on an item having a closed or schedule closed time. Since there is no strategic or perceived benefit in a bidder B delaying their competitive bid, total event time will be significantly reduced utilizing the method and system 10. Further, the presently-invented system 10 provides various interfaces 56, 58 and modes for use in effectively implementing the method and modifying phase duration and offer price “on the fly” during the negotiation. Accordingly, the method and system 10 of the present invention is dynamic and leads to a more effective and fair negotiation process.

Similar to a traditional manual auction, the method and system 10 of the present invention allows for real-time negotiations based on the concept of the item bidding remaining open until all bids are placed. Although the method 100 and system 10 is in a network environment N, it effectively emulates a true manual auction while still obtaining the benefits of instant global communications. Using the rule set 54 (and/or allowing the coordinator C control at the interface 58), and in either a manual, semi-automatic or fully automatic mode, the system 10 allows for the dynamic adjustment of parameters, such as the phase duration and the offer price, in order to ensure the event closely approximates the published event schedule while obtaining true market pricing. Currently, online auctions provide a forum for bidders B to place bids over the Internet, but do not include any intelligence around the rule of an auctioneer A. Unlike other online auction systems, the presently-invented method and system 10 effectively models an actual auctioneer A.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method of facilitating a negotiation for at least one item or service on at least one computer having a computer readable medium having stored thereon instructions, which, when executed by a processor of the computer, causes the processor to implement the method comprising:
entering at least one phase of the negotiation for the at least one item or service; and
during the at least one phase of the negotiation, dynamically adjusting the duration of the at least one phase of the negotiation based at least in part upon data that is existing or obtained during the at least one phase of the negotiation, wherein the data comprises at least one of the following: rate of bids received, bid submission time in relation to at least one other bid submission time, identification of submitter of at least one bid, variance between at least one bid value and the offer price, variance between at least one bid value and at least one other bid value, or any combination thereof.

2. (canceled)

3. The method of claim 1, further comprising during the at least one phase of the negotiation, dynamically adjusting an offer price for the at least one item or service based at least in part upon the data that is existing or obtained during the at least one phase.

4. The method of claim 1, further comprising:
entering an initial offer phase for the at least one item or service; and
setting an offer price for the at least one item or service.

5. The method of claim 1, further comprising:
entering at least one closing phase;
while in the at least one closing phase, entering at least one subsequent offer phase based at least on part upon the data that is existing or obtained during the at least one closing phase; and
while in the at least one subsequent offer phase, entering at least one subsequent closing phase based at least in part upon the data that is existing or obtained during the at least one subsequent offer phase.

6. The method of claim 1, wherein the negotiation is facilitated between at least one bidder user and at least one bid coordinator user.

7. The method of claim 6, wherein the at least one bidder user is at least one of a participating bidder and an observer affiliated with the participating bidder.

8. The method of claim 6, wherein the at least one bid coordinator user is at least one of a bid coordinator and an observer affiliated with the bid coordinator.

9. The method of claim 1, further comprising notifying a bidder user of a winning bid based upon a bid submitted by the bidder user during the negotiation.

10. The method of claim 1, further comprising providing an indication of the at least one phase to at least one of the following: a bidder user, a bid coordinator user, a participating bidder, an observer affiliated with the participating bidder, a bid coordinator, an observer affiliated with the bid coordinator.

11. A computer-implemented method of facilitating a negotiation for at least one item or service on at least one computer having a computer readable medium having stored thereon instructions, which, when executed by a processor of the computer, causes the processor to implement the method comprising:
entering at least one phase of the negotiation for the at least one item or service;
setting an offer price for the at least one item or service; and
during the at least one phase of the negotiation, dynamically adjusting the offer price for the at least one item or service based at least in part upon data that is existing or obtained during the at least one phase of the negotiation, wherein the data comprises at least one of the following: rate of bids received, bid submission time in relation to at least one other bid submission time, identification of submitter of at least one bid, variance between at least one bid value and the offer price, variance between at least one bid value and at least one other bid value, or any combination thereof.

12. The method of claim 11, further comprising:
during the at least one phase of the negotiation, dynamically adjusting the duration of the at least one phase of the negotiation based at least in part upon the data that is existing or obtained during the at least one phase of the negotiation.

13. A computer-implemented method of facilitating a negotiation for at least one item or service on at least one computer having a computer readable medium having stored thereon instructions, which, when executed by a processor of the computer, causes the processor to implement the method comprising:
entering at least one phase of the negotiation for the at least one item or service;
setting an offer price for the at least one item or service; and
during the at least one phase of the negotiation, dynamically adjusting at least one of (i) the duration of the at least one phase and (ii) the offer price for the at least one item or service, based at least in part upon data that is existing or obtained during at least one phase of the negotiation, wherein the data comprises at least one of the following: rate of bids received, bid submission time in relation to at least one other bid submission time, identification of submitter of at least one bid, variance between at least one bid value and the offer price, variance between at least one bid value and at least one other bid value, or any combination thereof.

14. A negotiation system for facilitating a negotiation for at least one item or service, comprising:
a central negotiation system comprising at least one computer having a computer readable medium having stored thereon instructions, which, when executed by a processor of the computer, causes the processor to:
(i) enter at least one phase of the negotiation for the at least one item or service;
(ii) set an offer price for the at least one item or service; and
(iii) during the at least one phase of the negotiation, dynamically adjust at least one of (i) the duration of the at least one phase and (ii) the offer price for the at least one item or service, based at least in part upon data that is existing or obtained during at least one phase of the negotiation, wherein the data comprises at least one of the following: rate of bids received, bid submission time in relation to at least one other bid submission time, identification of submitter of at least one bid, variance between at least one bid value and the offer price, variance between at least one bid value and at least one other bid value, or any combination thereof; and
a communication system configured to facilitate data communication between a plurality of users.

15. The system of claim 14, comprising a rule set defining at least one parameter of the negotiation, wherein the rule set is at least one of the following: dynamic, adjustable, implemented, automatically implemented, manually implemented, implemented in a combined manual/automatic environment.

16. The system of claim 14, wherein the central negotiation system is further configured to provide at least one of the following: an indication of the at least one phase to at least one of the plurality of users; and an indication of the offer price to at least one of the plurality of users.

17. The system of claim 16, further comprising a negotiation user interface for presentation to at least one of the plurality of users, the negotiation user interface configured to display data received, stored, processed or transmitted from the central negotiation system.

18. The system of claim 17, wherein the negotiation user interface is further configured to display at least one indicator to a user indicating at least one aspect or parameter of the negotiation.

19. The system of claim 14, further comprising a negotiation control interface for presentation to the at least one bid coordinator user, the negotiation control interface configured to display data received, stored, processed or transmitted from the central negotiation system.

20. The system of claim 19, wherein the negotiation control interface comprises a plurality of areas configured to present data to the bid coordinator user on a monitor in communication with the at least one computer.

21. The system of claim 19, wherein the negotiation control interface comprises at least one of the following:
a summary area for presenting data comprising at least one of the following: item data, service data, summary data, time data, leading bid data, leading user data, leading price data;
a bid activity area for presenting data comprising at least one of the following: user data, bid data, current bid data, next action data, bidder intent data, potential bid data, bid history data, bid order data, bid placement data, bid detail data, bid entry data, bid submission data, indication data, intention data, bid qualification data, bid leader data, bid ranking data;
an event schedule area for presenting data comprising at least one of the following: time data, schedule data, event schedule time data, tracking data, actual event time data, actual negotiation time data, current event time data, current negotiation time data, indication data, intention data, negotiation identity data, current time data; and
an event control area for presenting data comprising least one selectable element permitting data input from the bid coordinator user to the central negotiation system through the negotiation control interface.

22. The system of claim 21, wherein the event control area comprises a plurality of selectable elements configured to engage in at least one of the following: (i) remove a bid; (ii) remove a user; (iii) select a negotiation; (iv) select an event; (v) input an offer price; (vi) select a negotiation phase; (vii) close the negotiation; (viii) place the negotiation on hold; (ix) broadcast data.

23. The system of claim 19, wherein the data is at least one of the following: selectable, sortable, dynamic, modifiable, automatically provided, manually provided, static, indicated.

24. The system of claim 14, wherein at least one of the plurality of users is at least one of the following: a bidder user, a participating bidder, an observer affiliated with the participating bidder, a bid coordinator user, a bid coordinator, an observer affiliated with the bid coordinator.

25. A negotiation control interface on at least one computer having a computer readable medium having stored thereon instructions, which, when executed by a processor of the computer, causes the processor to implement the instructions, the negotiation control interface configured for use in connection with a negotiation system for facilitating a negotiation for at least one item or service and comprising at least one area configured to present bidder intent data to a control user during at least one phase of the negotiation; wherein the bidder intent data is received, stored, processed and/or transmitted from the central negotiation system, wherein the bidder intent data comprises data indicative of at least one of the following: a bidder being a potential bidder or about to bid; an amount of a bid as entered in at the bidder's computer, but not submitted; a bid that is keyed-in at the bidder's computer, but not submitted; an adjusted keyed-in bid, but not submitted; a duration of time passed before, during or after a bid is keyed-in, but prior to submission; number of adjustments to a keyed-in bid prior to submission; how a bidder, prior to submission, adjusts and/or enters a keyed-in bid in relation to market dynamics; or any combination thereof.

26. A negotiation control interface on at least one computer having a computer readable medium having stored thereon instructions, which, when executed by a processor of the computer, causes the processor to implement the instructions, the negotiation control interface configured for use in connection with a negotiation system for facilitating a negotiation for at least one item or service and comprising at least one area accessible by a user to configure at least one rule that defines at least one parameter of the negotiation, wherein, during at least one phase of the negotiation and based upon data existing or obtained during the negotiation and the at least one rule, the system is configured to dynamically adjust at least one of the following: the duration of at least one phase of the negotiation, the offer price for the at least one item or service, or any combination thereof; wherein the data comprises at least one of the following: rate of bids received, bid submission time in relation to at least one other bid submission time, identification of submitter of at least one bid, variance between at least one bid value and the offer price, variance between at least one bid value and at least one other bid value, or any combination thereof.
